(19) United States
(12) Patent Application Publication
(10) Pub. No.: US 2004/0099487 A1
(43) Pub. Date: May 27, 2004

(54) Wheel hub locking mechanism for wheelchair

(76) Inventor: Alejandro Melgarejo, Simi Valley, CA (US)

Correspondence Address: OPPENHEIMER WOLFF & DONNELLY LLP, 2029 Century Park East, 38th Floor, Los Angeles, CA, 90067-3024, US

(21) Appl. No.: 10/307,185

(22) Filed: Nov. 27, 2002

(51) Int. Cl. B62J 1/00

(52) U.S. Cl. 188/2 F; 280/304.1

(57) ABSTRACT

A wheelchair wheel hub locking mechanism is provided to positively lock a wheelchair wheel to the associated wheelchair frame and includes a locking ring member of cylindrical shape fixed to the inner side of the wheelchair wheel hub, the locking ring providing a plurality of dog receiving cages, each cage presenting a dog receiving opening formed by surround walls integral of the ring. A dog and dog mounting plate are mounted to a member of the wheelchair frame, the position of the dog being controlled by movement of an association handle connected by a cable to the dog, forward movement of the handle raising the dog away from cages of the locking ring, movement of the handle rearwardly of the wheelchair allowing the dog under spring bias to move against the locking ring until wheel movement aligns a cage of the ring with the dog and the two lock up.

### BACKGROUND OF THE INVENTION

The present invention relates to a wheelchair wheel locking mechanism for providing a positive, secure lock of the wheelchair, via one of the rear wheels of the wheelchair, when movement of the wheelchair is to be disabled.

It has been known heretofore to provide friction type brake locking mechanisms for wheelchairs which are normally manipulative by the person pushing the wheelchair who can via handgrips operate the wheelchair friction brake when maneuvering the wheelchair. Such friction brakes are not normally provided in such a way as to facilitate locking of the wheelchair when it is not occupied, such as when being put in storage or being loaded into a vehicle for movement as part of the delivery or relocation of the wheelchair for future use. It has thus been recognized that it would be desirable to provide a locking mechanism which is easily operated by an occupant, or a non-occupant, which disables the wheelchair from movement until the locking mechanism is released. Such locking mechanism is desirably associated with at least one of the larger rear wheels of the wheelchair and it provided so as to provide a positive secure lock of such wheel against movement when such movement is not desired.

### SUMMARY OF THE INVENTION

It is an object of the present invention to provide a wheelchair wheel locking mechanism which overcomes disadvantages of prior friction brakes and provides a positive secure lock of a wheelchair wheel so as to immobilize the chair when so desired as when the chair is being stored or moved during initial deliver or relocation of the wheelchair for future use.

As is contemplated within the present invention, a locking member is provided on an inner side of the hub of a wheelchair which can cooperate with a dog movable by an operating lever such that when the dog and locking member are engaged, the wheel is immobilized.

More specifically, a locking ring member of cylindrical shape is fixed to the inner side of the hub of a wheelchair wheel in accordance with a preferred exemplary embodiment of the present invention, the ring having one or more dog receiving apertures provided by surrounding aperture walls integral of the ring. The walls and opening providing a cage into which the dog can be received. In the preferred exemplary embodiment, the exemplary dog has tapered side surfaces to fit within an associated cage on the locking ring and is mounted in association with a mounting plate so as to be controlled between ring engaging and ring release position for a cable connected between the control lever and dog. The lower end connection between the cable and dog is provided in a lost motion connection with the dog being biased toward the rings so that when the cable is moved by the associated handle to bring the dog to the ring, the cable actually releases the dog which is spring bias toward the ring and snaps into a cage aligned through relative movement of the wheel and dog until such alignment exists.

A more complete understanding of the present invention and the expression thereof in a preferred exemplary embodiment will now be afforded to those skilled in the art by a consideration of the following detailed description of such preferred embodiment. Before the detail description, however, a brief description of the drawings is provided.

### BRIEF DESCRIPTION OF THE DRAWINGS

FIG. 1 is a perspective view of a conventional wheel chair having the wheelchair wheel locking mechanism in accordance with the present invention;

FIG. 2 is an exploded view of the wheel, wheel hub, locking ring and locking dog mechanism provided adjacent the wheel hub and locking ring in accordance with the present invention;

FIG. 3 is an exploded view of the wheel locking lever or handle A associated with its mounting clamps for mounting to the wheel chair frame in association with the dog operating cable of the locking mechanisms of FIGS. 1 and 2;

FIG. 4 is a detailed view of the locking ring and dog mounting means of the present embodiment of FIGS. 1 and 2 showing the dog engaged in a cage of the locking ring locking the wheelchair wheel in a positive locked or stopped position in accordance with the present invention; and

FIG. 5 is a detailed view as in FIG. 4 showing the locking dog withdrawn from a cage of the associated locking ring of the wheelchair wheel releasing the wheel for movement.

### DETAILED DESCRIPTION OF THE PREFERRED EMBODIMENTS

A conventional wheelchair, in accordance with the disclosures of co-pending applications Ser. No. 09/963,321 and Ser. No. 10/198,299 owned by the common Assignee of the present application is indicated at 10, the disclosures of such applications being incorporated herein by reference.

The wheelchair indicated generally at 10 includes seat 11 and seatback 12 mounted in conventional manner to seat frame 13. Frame 13 includes a left frame bar 14, right frame bar 15, left vertical bar 16 and right vertical bar 17. Handles including left handle 18 and right handle 19 may have conventional friction brakes including handgrips 20 and 21, respectively. When maneuvering the wheelchair with or without an occupant, the handbrakes 20, 21 may be employed by the person moving the wheelchair to brake the wheel motion in known manner. In accordance with the present invention, an additional positive wheel lock is provided which is operable by the occupant or wheelchair operator to assure that a wheel is held in locked position whether brakes 20 and 21 are being manipulated or not.

As it is also known in provisional conventional wheelchairs, a left armrest 22 and right armrest 23 may be provided for the convenience of the occupant. A conventional headrest 24 is also illustrated.

The present embodiment of wheelchair, indicated at 10, has a lower chair frame indicated generally at 30 which includes a left side upper bar 31 and lower left side bar 32 providing the left hand side of the frame member. A right side upper frame bar 33 and a right side lower frame bar 34 may provide the right hand side of the lower frame. Appropriate cross braces, not illustrated in the present embodiment, are provided as indicated in the co-pending applications noted above for providing a lower frame upon which the upper seat frame may be adjustably mounted.

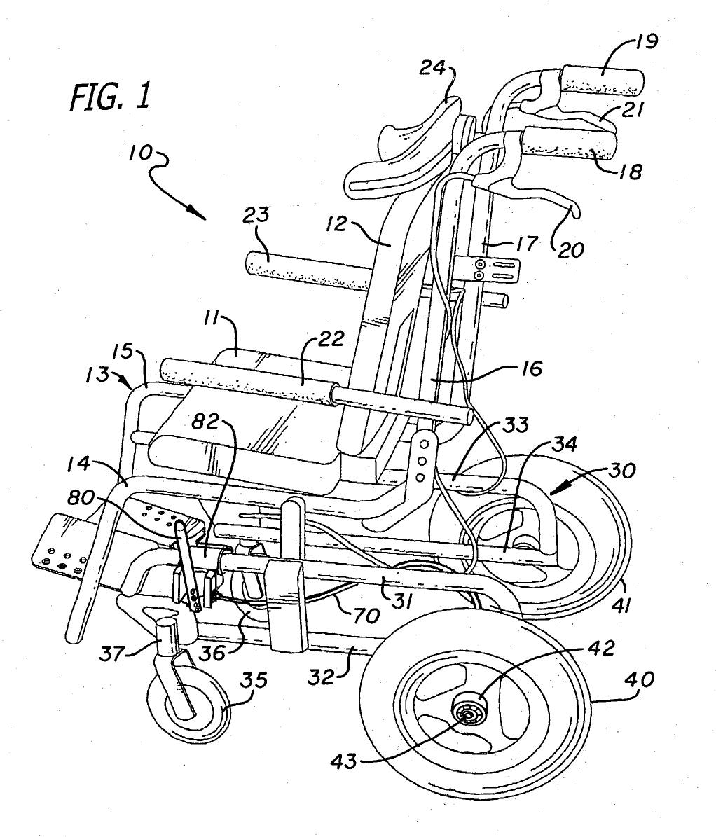

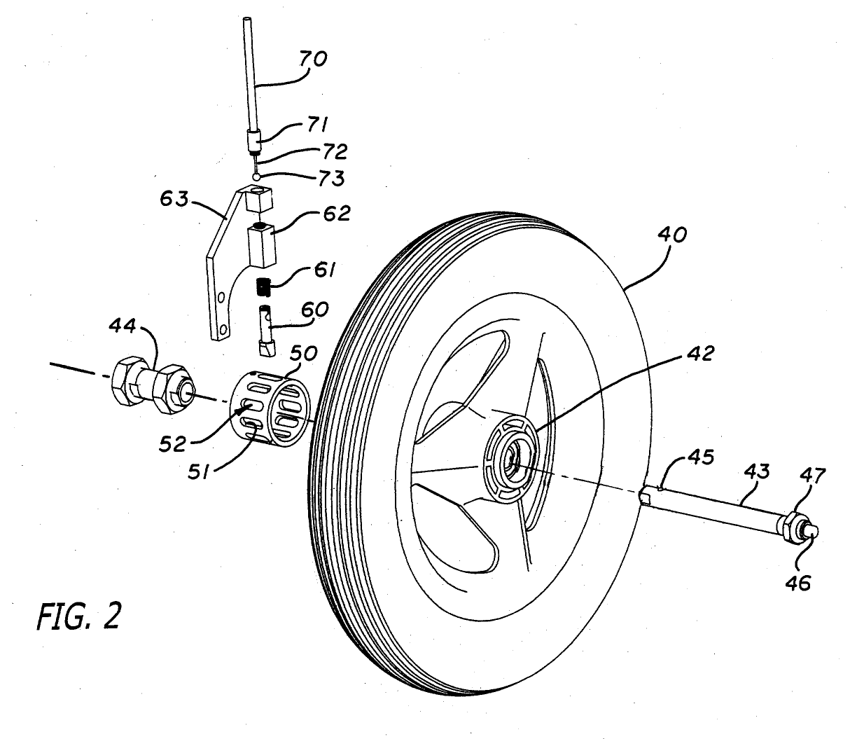

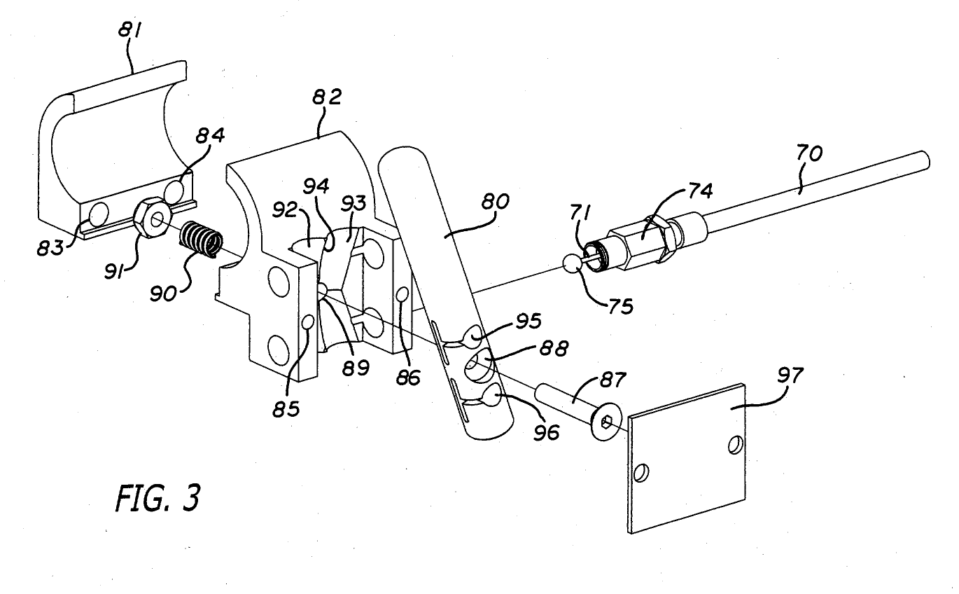

As further known in conventional wheel chair art, front left and right wheels 35 and 36 may be provided and mounted by known caster mechanisms as is illustrated at 37 in FIG. 1. Larger wheels are generally provided at the rear of the wheelchair to carry the weight of the occupant and allow maneuvering of the wheelchair by an operator. In the present embodiment, the rear wheels include left wheel 40 and right wheel 41. In the present embodiment, left wheel 40 is provided with an especially designed wheel hub a best seen in FIG. 2 and is mounted by wheel axle 43, also as seen in FIG. 2 to the lower wheelchair frame 30. Before describing the locking mechanism associated with wheel 40, it may be seen in FIG. 1 that a wheel locking handle 80 is mounted to lower frame bar 31 by a pair of clamps including clamp 82 as best seen in FIG. 3, the cover plate 97 having been removed in the illustration of FIG. 1. Handle 80 may be adjusted between a forward wheel locking position and a rearward wheel unlocking position, to handle movement operating a cable within cable sleath 70 for controlling a locking dog as will subsequently be described in association with the disclosures of FIGS. 2-5.

Referring now to FIG. 2, and as contemplated within the present invention, wheel 40 is provided with a hub 42, the inner end of which mounts, and fixed relation, a locking ring 50. The wheel is mounted to the wheelchair frame via axle 43 which snap fits into axle receiver 44 mounted to frame member 32. As is known in the prior art, axle 43 may have a detente 45 operable by push button 46 on the outer end of the axle so as to facilitate a quick release mounting of wheel 40, to allow interchangeability of the size of the wheels, by simply snap fitting axle 43 into the receptacle 44 fixed to the lower frame member 32. Nut 47 on the outer end of the axle retains wheel 40 to the wheelchair when the axle is assembled as discussed.

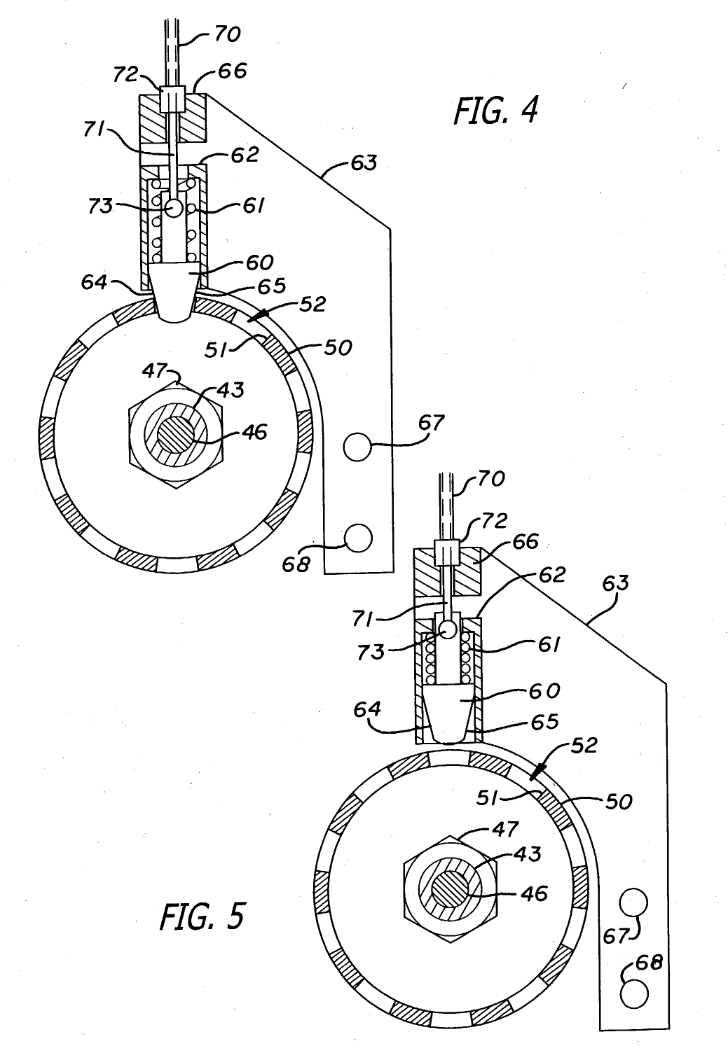

As contemplated within the present invention, the locking ring 50 mounted to the inner end of wheel hub 42 is provided with a plurality of dog receiving cages, as cage 51, for example, each cage providing an opening 52 into which the dog may be inserted. The sidewalls of the openings 51, integral with ring 50, form the individual cages in which the dog can be selectively inserted by moving the handle 80 to push the spring bias dog toward the cages accompanied with some wheel movement until a cage is selected. As seen in FIG. 2, dog 60 has a downward bias by virtue of coil spring 61, the two being mounted within dog receptacle 62 provided on mounting plate 63 as best seen in FIGS. 4 and 5. Dog 60 has tapered sidewalls for 64 and 65 to facilitate its fit into a cage providing an opening, as opening 52, in ring 50. As seen in FIG. 4, a lower end of cable sleath 70 is secured by sleeve fitting 72 being fixedly retained within the upper receptacle 66 on mounting plate 63. As is known in the fastening art, dog 73 on the end of the cable 72 fits within a receptacle at the rear end of dog 60 secure it to the cable. By moving handle 70 forward and the wheelchair as seen in FIG. 1, the cable lifts the dog 60 to the wheel unlocking position of FIG. 5. A pushing of handle 82 a rearward position as seen in FIG. 1, the cable 71 within cable sleath 70 releases the dog to be moved under its bias of spring 61 toward ring 50, the dog entering an aligned cage having an opening such as opening 52 on slight forward or backward movement of the wheel once the handle has been moved to the rearward locking position as seen in FIG. 1. The mounting plate 63 may be secured by conventional fasteners and clamps to the lower left frame member 32 in association with the mounting apertures 67 and 68 provided on plate 63. Plate 63 is positioned on frame member 32 in order to be associated with the locking ring 50 provided on the inner end of hub 42 of wheel 40.

Referring now to FIG. 3, handle 80, as seen in FIG. 1, is clamped by the bolting of inner clamp 81 to outer clamp 82 about the left side upper bar 31 of the frame indicated at 30. Lever 80 is mounted for forward and backward movement by the operator to the lower frame indicated at 30 by clamps 81 and 82. The inner clamp has threaded bolt receiving holes 83, 84 while the outer clamp has bolt receiving apertures 85 and 86 to receive bolts, not shown, to fix the two clamp members to bar 31 in a stationary position. Handle mounting bolt 87 passes through aperture 88 in a non-binding, freely relative rotational manner to facilitate handle movement, passes through bar 89 and outer clamp 82 and is secured in a resilient mounting relation to client 82 via compression spring 90 and bolt and associated, nut 91. Handle 80 is thus resiliently held to clamp 82 with sufficient freedom of movement so as to be able to move the handle from a forward handle receiving position within curved receiving portion 92 of clamp 82 subject to movement to a rearward position for handle 80 in the curved receiving portion 93, there being a détente or pointed abutment between curved surfaces 92 and 93 as indicated at 94 over which the handle must be moved between the forward wheel unlocking position and the rearward wheel locking position, handle 80 resting within the curved surfaces 92 and 93, respectively when in the aforcesive positions. A cover plate 97, not seen in FIG. 1, may be provided to cover the handle mounting mechanism as seen in FIG. 3. Plate 97 being mounted thereto by being prepositioned before inserting bolts through openings 85 and 86 which mount the two clamp members together.

Having thus described a preferred exemplary embodiment of the wheelchair wheel hub locking mechanism in accordance with the present invention, it should be understood by those skilled in the art the various alternatives, modifications and adaptations thereof can be made within the scope of the present invention which is defined by the following claims.

We claim:

1. A wheelchair wheel locking mechanism to immobilize said wheel, said locking mechanism comprising:
a locking dog and means for movably mounting said dog on a frame of said wheelchair;
locking dog receiving means on a wheel of said wheelchair to immobilize wheel movement when said locking dog is received; and
control means for controlling movement of said dog into and out of engagement with said dog receiving means.

2. A wheelchair wheel locking mechanism of claim 1 when said locking dog receiving means includes a cylindrical locking means member fixed to an inner side hub of said wheel, said ring having a plurality of dog receiving apertures.

3. The wheel locking mechanism of claim 2 when said locking dog mounting means includes means for providing a bias of said dog toward said ring and ring apertures, said control means releasing said dog to move under its bias into a wheel locking position when said control means is operated to allow dog engagement with said ring.

4. A wheelchair wheel hub locking mechanism for providing a positive secure lock of a wheelchair wheel to the wheelchair frame in addition to conventional wheelchair friction brakes, said locking mechanism comprising:
a locking ring member of cylindrical shape fixed to the inner side of said hub of a wheelchair wheel, said ring having one or more dog receiving cages, each cage presenting a dog receiving opening formed by surrounding walls integral of said ring member;
a dog and a dog mounting plate secured to a frame member of said wheelchair frame; and
a dog control handle and a cable connecting between said dog and handle for moving said dog into and out of a cage on said side wheel hub ring to respectively lock and release said wheel.

5. A wheelchair wheel locking mechanism to selectively immobilize said wheelchair against its movement through use of its wheels, said locking mechanism comprising:
a dog movably mounted off of a frame member of said wheelchair for movement between first and second positions;
a dog receiving member fixed to a wheel of said wheel chair; and
a control lever and associated cable connecting said lever to said dog for moving said dog, one of said first and second positions of said dog being a wheel rotation immobilization position wherein said dog engages said dog receiving member.

6. A wheelchair wheel locking mechanism comprising:
a dog receiving locking member mounted to a wheel of a wheelchair;
a dog adapted to interact with said locking member;
a dog mounting mechanism associated with said wheelchair to mount said dog for movement between a first position where said dog is not engaging said locking member on said wheel and a second position where said dog engages said locking member on said wheel to interact with said locking member and wheel against wheel rotation; and
a control lever operable to move said dog between said first and second positions.

7. A wheelchair locking mechanism comprising:
a locking dog and means for moving said dog between wheel locking and wheel unlocking positions by manipulation of an associated handle; and
a wheelchair wheel hub associated dog receiving means for receiving said dog in one or more dog receiving openings, said wheel being locked in a stationary position when said dog is in one of said dog receiving openings.

8. The locking mechanism of claim 7 when a locking dog has a conversion tapered end to fit snuggly in one of said one or more dog receiving openings.

9. The locking mechanism of claim 8 when said means removing said dog includes a cable connected between said dog and handle and means for biasing said handle to remain in a selected dog log or dog unlocking position when manually moved to said positions.
